(19) United States
(12) Patent Application Publication
(10) Pub. No.: US 2024/0166169 A1
(43) Pub. Date: May 23, 2024

(54) Trailer Jack Add-On Gearbox

(71) Applicant: Red Patriot Inc., Deland, FL (US)

(72) Inventor: James Anthony Jusick, Eusits, FL (US)

(21) Appl. No.: 18/502,902

(22) Filed: Nov. 6, 2023

Related U.S. Application Data
(60) Provisional application No. 63/426,198, filed on Nov. 17, 2022.

(51) Int. Cl. B60S 9/04; F16H 19/02; F16H 57/02

(52) U.S. Cl. CPC B60S 9/04; F16H 19/02; F16H 57/02; F16H 2057/02082

(57) ABSTRACT

A removable gearbox has a plurality of gears in a housing and connected to a gear shaft and an input shaft of a trailer to allow the trailer to be raised and lowered with a battery operated drill.

### REFERENCE TO RELATED CASE

This application claims priority under 35 U.S.C. § 119 (e) to U.S. provisional application No. 63/426,198 filed on Nov. 16, 2022, the contents of which are hereby incorporated by reference in their entirety.

### BACKGROUND OF THE INVENTION

Most trailers are manufactured with one or more jacks to facilitate the raising and lowering of the front of the trailer when coupling or uncoupling with a tow vehicle (not shown). The jacks have an input shaft that is turned by a handle by the operator to raise or lower the front of the trailer. This turning of the handle by hand is difficult, requires significant effort and results in lost time and many injuries to the operator performing the work. Many trailers have to be delivered to or picked up from a spot requiring the tow vehicle to block the flow of traffic while uncoupling the trailer. The slow process of raising or lowering the front of the trailer by hand amplifies issues caused by the blocked traffic.

Thus, Applicant has invented a gearbox that can more easily lift and/or lower the front of a trailer by using a cordless drill.

### SUMMARY OF THE INVENTION

According to one aspect, the present invention is directed to a removable gearbox to change a height of a trailer jack that includes a housing having a front and a back, a plurality of gears disposed within the housing, an input shaft receiver operatively connected to one of the plurality of gears, the input shaft receiver configured to receive at least a portion of an input shaft of the trailer jack therein and wherein the input shaft of the trailer is rotated to move a portion of the trailer jack up or down, at least one gear shaft extending through the front of the housing, the at least one gear shaft attached to the another of the plurality of gears and the another of the plurality of gears is operatively connected to the one of the plurality of gears; and two anti-rotation projections disposed on and extending away from the back of the housing to engage the trailer jack.

In some embodiments, the plurality of gears comprises a first gear, a second gear, a third gear, and a fourth gear and the one of the plurality of gears is the fourth gear and the another of the plurality of gears is the first gear.

In some embodiments, the input shaft of the trailer jack passes through at least one opening in the housing.

In some embodiments, there is a second gear shaft extending through the front of the housing and being connected to the third gear, the third gear operatively connected to the fourth gear.

In some embodiments, rotating the second gear shaft causes the second gear and the third gear to rotate, which in turn causes the first gear and third gear to rotate, the second gear rotates the first gear and the third gear rotates the fourth gear causing the input shaft of the trailer jack to rotate.

In some embodiments, the first gear and the third gear have a first number of teeth, the second gear has a second number of teeth, and the fourth gear has a third number of teeth, where the third number of teeth is greater than the second number of teeth, and the second number of teeth is greater than the first number of teeth.

In yet another aspect, there is a removable gearbox to change a height of a trailer jack that includes a housing having a front and back, a first gear, a second gear, a third gear and a fourth gear disposed within the housing, an input shaft receiver operatively connected to the fourth gear, the input shaft receiver configured to receive at least a portion of an input shaft of the trailer jack therein; and a first gear shaft extending through the front of the housing, the first gear shaft is attached to the first gear and rotationally engages the second gear that is operatively connected to the input shaft receiver.

In some embodiments, the second and third gear are disposed on the same gear shaft, the third gear rotationally engaging the fourth gear thereby rotating the input shaft.

In some embodiments, rotating the first gear shaft causes the first gear to rotate, which in turn causes the second gear and third gear to rotate, which in turn causes the fourth gear to rotate the input shaft of the trailer jack.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of one version of a trailer jack and one embodiment of a gearbox according to the present invention;

FIG. 2 is a perspective view from the right front of the gearbox in FIG. 1;

FIG. 3 is a perspective view from the top front of the gearbox in FIG. 1;

FIG. 4 is a perspective view from the right rear of the gearbox and part of the trailer jack in FIG. 1;

FIG. 5 is a perspective view from the left rear of the gearbox in FIG. 1;

FIG. 6 is a perspective view from the right front of the gearbox in FIG. 1 with the front cover removed;

FIG. 7 illustrates the gearbox of FIG. 1 with the input shaft received rotated 180 degrees and coming out of the back;

FIG. 8 is an exploded view from the front right side of the gearbox in FIG. 1;

FIG. 9 is a perspective view from the front right side of a second embodiment of a gearbox according to the present invention;

FIG. 10 is a perspective view from the top front of the gearbox in FIG. 9;

FIG. 11 is a perspective view from the left rear of the gearbox in FIG. 9;

FIG. 12 is a perspective view from the right front of the gearbox in FIG. 9 with the front cover removed;

FIG. 13 is an exploded view from the front right side of the gearbox in FIG. 9;

FIG. 14 is an elevational view of the gearbox in FIG. 9 showing all of the gears;

FIG. 15 is a perspective view of one embodiment of a bracket that can be used with the embodiments of the gearboxes in FIGS. 1 and 9, but illustrated with the gearbox in FIG. 9;

FIG. 16 is a perspective view of the bracket in FIG. 15 from the right rear;

FIG. 17 is a perspective view from the front right side of the bracket in FIG. 15;

FIG. 18 is a front elevational view of a bracket according to the present invention to be used with the gearbox in FIG. 1 and a semi-tractor trailer;

FIG. 19 is a rear elevational view of the bracket in FIG. 18 mounted to the back of the gearbox in FIG. 1;

FIG. 20 is a front elevational view of the bracket and gearbox of FIG. 19 ready to be used on a semi-tractor trailer; and

FIG. 21 is a front elevational view of the bracket and gearbox of FIG. 19 attached to the semi-tractor trailer, ready to move it up or down.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

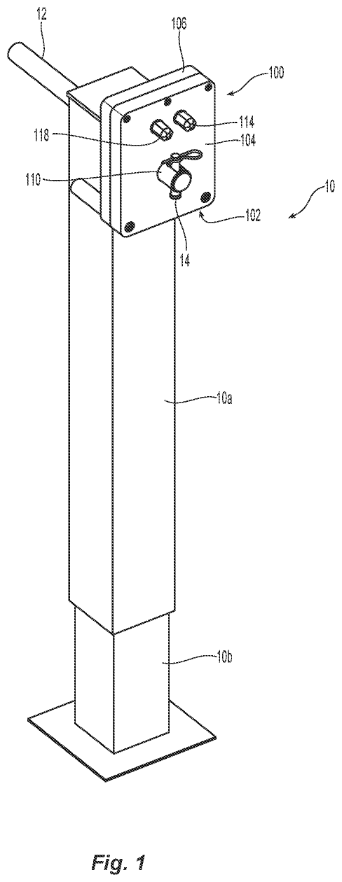

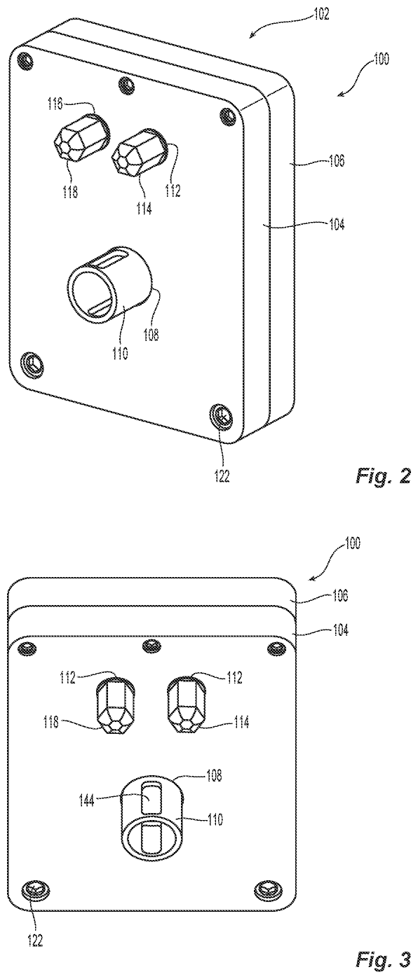

Illustrated in FIG. 1 is one example of a trailer jack 10 that has one embodiment of a removable gearbox 100 to change a height of the trailer jack 10. The trailer jack 10 generally has two portions 10a and 10b that are movable relative to one another to raise and lower the front portion of the trailer, where the jack 10 is mounted. There is an input shaft 12 associated with the trailer jack 10 which, when turned, moves the front of the trailer up or down by moving the portions relative to one another

The input shaft 12 of the trailer jack 10 is removably connected to the gearbox 100. By removable, Applicant means that the gearbox 100 is designed to be easily attached to and removed from the trailer jack 10 (or any conventional trailer jack) numbers of times. Thus, there are no parts that are destroyed during the removal of the gearbox 100 nor is there welding or other methods of securing parts together that make the gearbox 100 difficult to remove. It is designed to attached and unattached numerous times, e.g., hundreds if not thousands of times.

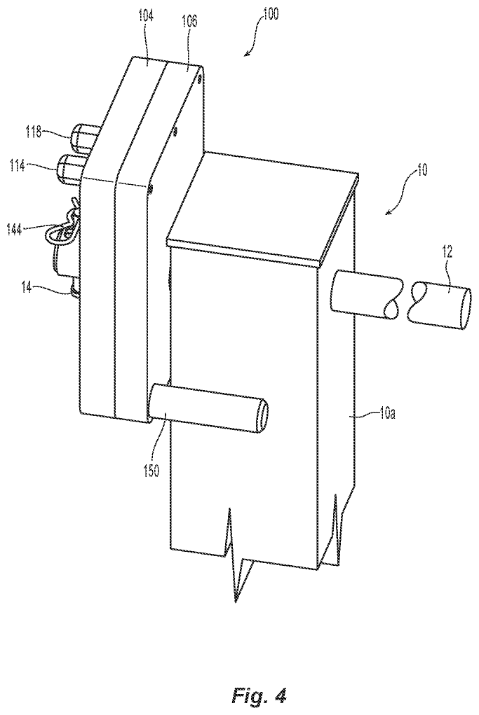

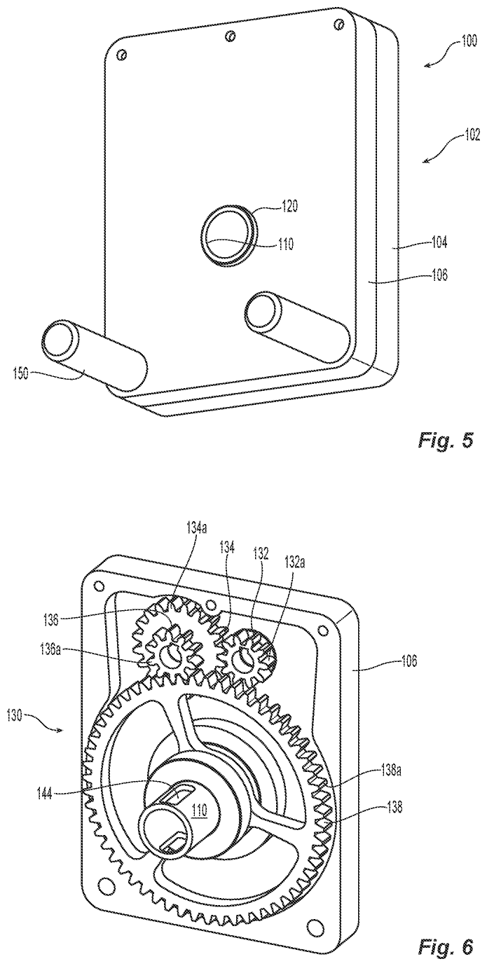

The removable gearbox 100 has a housing 102 that has a front 104 and a back 106. The housing 102 may be made of two mirror-image pieces. It is also possible that one of the front 104 and the back 106 is thicker than the other or that they are independent of one another. The front 104 has a number of openings therein. A first opening 108 is to receive the input shaft 12 and an input shaft receiver 110 that surrounds the input shaft 12 as discussed below. The second opening 112 is to receive a first gear shaft 114 and the third opening 116 is to receive a second gear shaft 118. As can be seen in FIGS. 4 and 5, the second opening 112 and the third opening 116 do not extend through the back 106, although it is possible. However, the input shaft receiver 110 preferably extends through an opening 120 in the back 106. One of skill in the art would know that the second and third openings may also extend through the back 106.

The front 104 and the back 106 are attached to one another by screws 122 but could be attached by other methods as well.

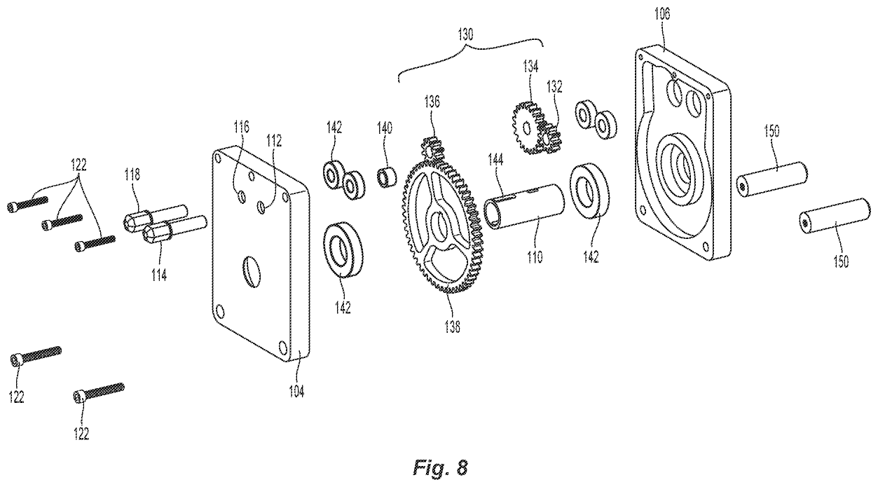

The removable gearbox 100 has a plurality of gears 130 disposed within the housing 102. See FIGS. 6 and 8. A first gear 132 is attached to the first gear shaft 114 so that when the first gear shaft 114 is rotated, so too does the first gear 132. The first gear 132 is operationally connected to a second gear 134. That is, when the first gear 132 is rotated, the second gear 134 also rotates. As is discernable from the figures, second gear 134 rotates counter to the first gear 132. Thus, if the first gear 132 is rotated in a clockwise manner, the second gear 134 rotates in a counter-clockwise direction, and vice-versa. It should be noted that the first gear shaft 114 and the second gear shaft 118 have openings to receive projections that engage a cut-out on the gears 130 as is common in the art. The engagement of the gear shafts to the gears may be done in many ways and still fall within the scope of the present invention.

The second gear 134 and the third gear 136 are both disposed on the second gear shaft 118. Thus, when the second gear shaft 118 rotates, so too do the second gear 134 and the third gear 136. The third gear 136 is operationally connected to the fourth gear 138. Thus, when the third gear 136 rotates, so too does the fourth gear 138—in counter direction. The third gear 136 may rotate by turning either of the first gear shaft 114 or the second gear shaft 118.

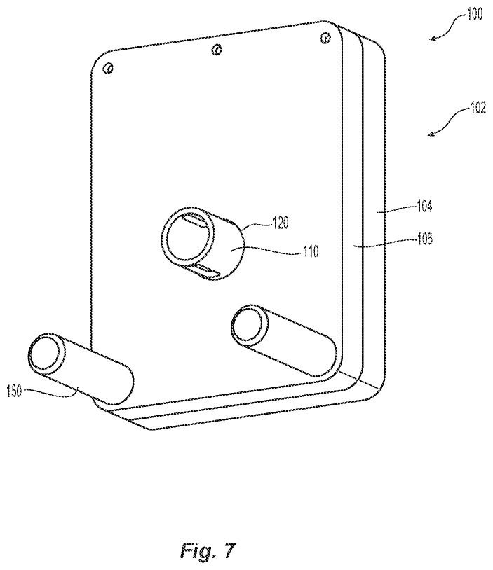

The fourth gear 138 is fixed relative to the input shaft receiver 110. If the fourth gear is rotated, through either of the gear shafts 114,118, then the input shaft receiver 110 rotates causing the trailer jack 10 to raise or lower the trailer to which it is attached. As illustrated in FIG. 7, there may be a number of spacers 140 and bearings 142 to assist in the smooth operation of the gearbox 100.

The gears 130 may have more or fewer teeth than illustrated in the figures. The first gear 132 and the third gear 136 have ten teeth 132a, 136a, while the second gear 134 has 20 teeth 134a. Finally, the fourth gear 138 has 55 teeth 138a. Again, this could be a matter of preference, the loads to be lifted, etc. See FIG. 11. These gears 130 allow the user to one gear shaft when more torque is needed and the other gear shaft with more speed and less torque.

The input shaft 12 from the trailer jack 10 has a pin 14 that engages an opening 144 on the input shaft receiver 110—thereby connecting the input shaft 12 with the input shaft receiver 110. Turning of the fourth gear 138 causes input shaft receiver 110 to rotate, which turns the input shaft 12 raising or lowering the trailer jack 10.

Illustrated in FIG. 7 is the gearbox with the input shaft receiver 110 extending out the back as an alternative in case the input shaft 12 is too short or the configuration allows for this alteration.

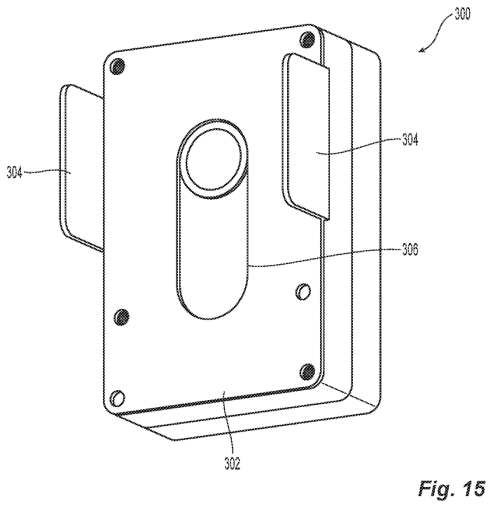

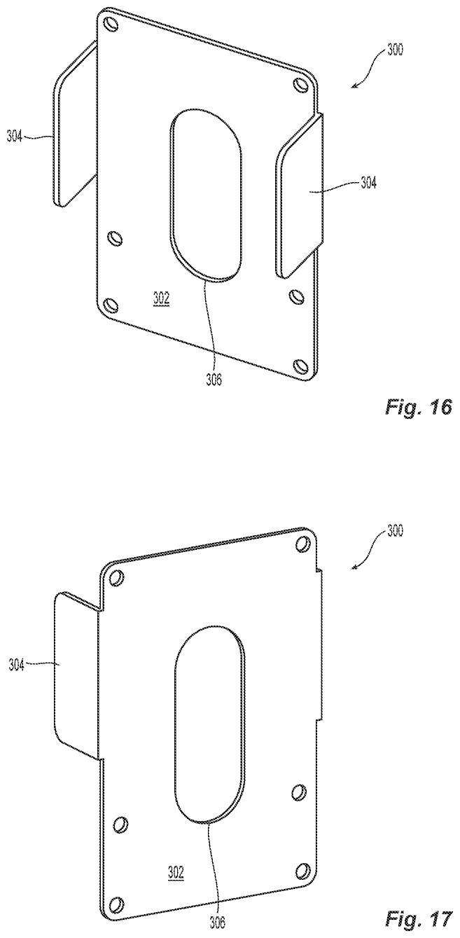

Extending outward from the back 106 and away from the gearbox 100 are two anti-rotation projections 150. The anti-rotation projections 150 are separated to the left and right sides of the gearbox 100 so that the trailer jack 10 can fit between the anti-rotation projections 150. While these anti-rotation projections 150 are attached to the gearbox 100 with screws (such as also with the screws 122 or even different ones), they could be attached in any other manner or be integral with the back 106. They may also take other forms, such as flat surfaces. See also FIGS. 15-17.

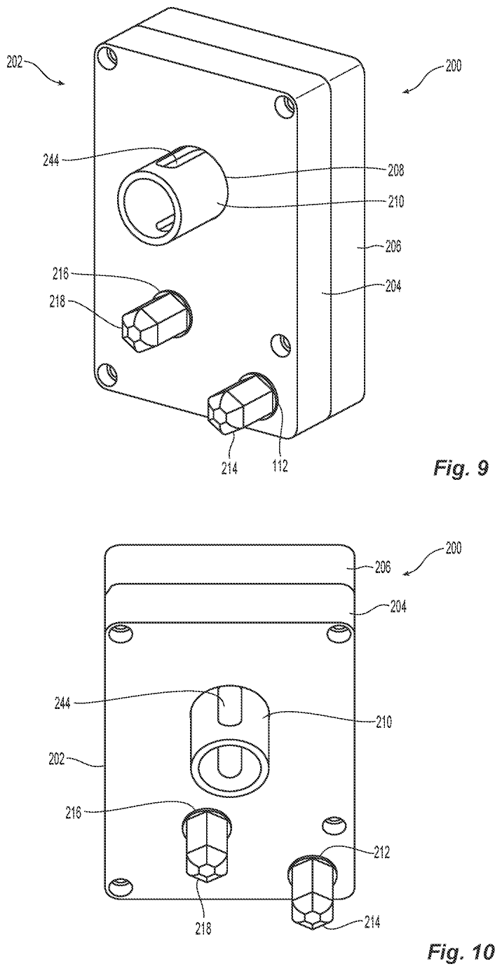

A second embodiment of a removable gearbox 200 according to the present invention is illustrated in FIGS. 9-14. In this embodiment, the size, placement of the gears, and the gear shafts have be relocated.

The removable gearbox 200 has a housing 202 that has a front 204 and a back 206. The housing 202 may be made of two mirror-image pieces. It is also possible that one of the front 204 and the back 206 is thicker than the other or that they are independent of one another. The front 204 has a number of openings therein. A first opening 208 is to receive the input shaft 12 and an input shaft receiver 210 that surrounds the input shaft 12 as discussed below. The second opening 212 is to receive a first gear shaft 214 and the third opening 216 is to receive a second gear shaft 218. As can be seen in FIGS. 10 and 11, the second opening 212 and the third opening 216 do not extend through the back 206, although it is possible. However, the input shaft receiver 210 preferably extends through an opening 220 in the back 206. One of skill in the art would know that the second and third openings may also extend through the back 206.

The front 204 and the back 206 are attached to one another by screws 222 but could be attached by other methods as well.

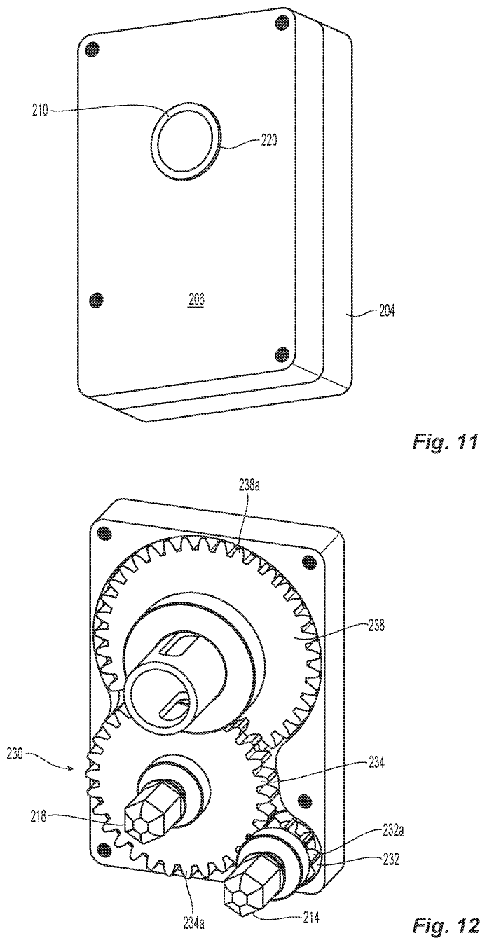

The removable gearbox 220 has a plurality of gears 230 disposed within the housing 202. See FIGS. 12-14. A first gear 232 is attached to the first gear shaft 214 so that when the first gear shaft 214 is rotated, so too does the first gear 232. The first gear 232 is operationally connected to a second gear 234. That is, when the first gear 232 is rotated, the second gear 134 also rotates. As is discernable from the figures, second gear 234 rotates counter to the first gear 232. Thus, if the first gear 232 is rotated in a clockwise manner, the second gear 234 rotates in a counter-clockwise direction, and vice-versa. It should be noted that the first gear shaft 214 and the second gear shaft 218 have openings to receive projections that engage a cut-out on the gears 230 as is common in the art. The engagement of the gear shafts to the gears may be done in many ways and still fall within the scope of the present invention.

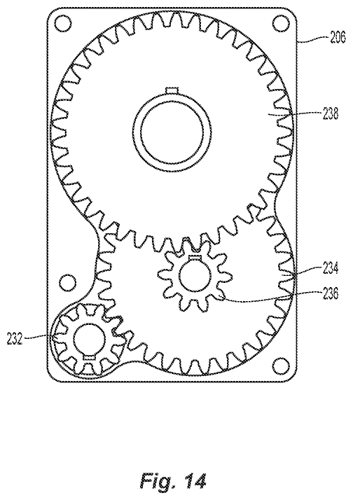

The second gear 234 and the third gear 236 are both disposed on the second gear shaft 218. The third gear 236 is behind the second gear 234 in FIG. 12. See FIGS. 12 and 14. Thus, when the second gear shaft 218 rotates, so too do the second gear 234 and the third gear 236. The third gear 236 is operationally connected to the fourth gear 238. Thus, when the third gear 236 rotates, so too does the fourth gear 238—in a counter direction. The third gear 236 may rotate by turning either of the first gear shaft 214 or the second gear shaft 218.

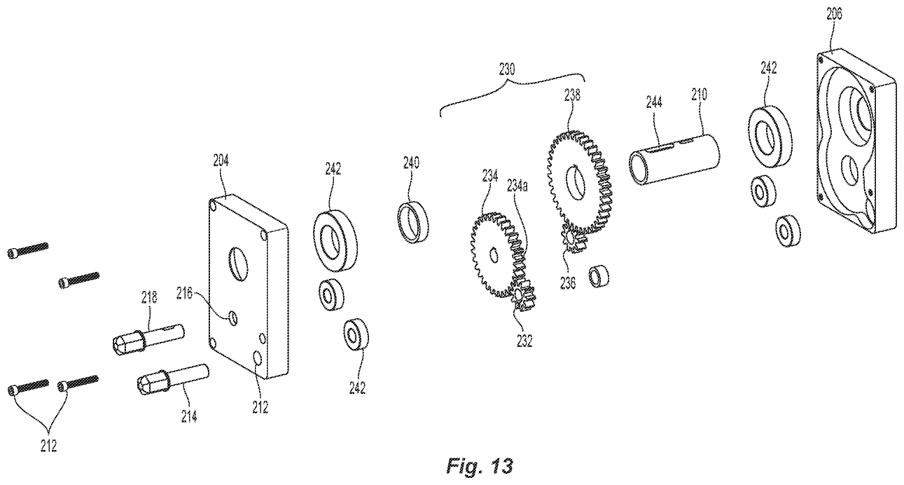

The fourth gear 238 is fixed relative to the input shaft receiver 210. If the fourth gear 238 is rotated, through either of the gear shafts 214,218, then the input shaft receiver 210 rotates causing the trailer jack 10 to raise or lower the trailer to which it is attached, depending on which way the gear shafts are turned. As illustrated in FIG. 13, there may be a number of spacers 240 and bearings 242 to assist in the smooth operation of the gearbox 100.

The gears 230 may have more or fewer teeth than illustrated in the figures. The first gear 232 and the third gear 136 have 10 teeth 232a,236a, while the second gear 234 has 30 teeth 234a. Finally, the fourth gear 238 has 37 teeth 238a. Again, this could be a matter of preference, the loads to be lifted, etc. See FIGS. 11 and 14.

The input shaft 12 from the trailer jack 10 has a pin 14 that engages an opening 244 on the input shaft receiver 210—thereby connecting the input shaft 12 with the input shaft receiver 210. Turning of the fourth gear 238 causes input shaft receiver 210 to rotate, which turns the input shaft 12 raising or lowering the trailer jack 10.

A bracket 300 to be used with the removable gearboxes (100/200) is illustrated in FIGS. 15-17. The bracket 300 has a back member 302 with two extensions 304 extending outward from the back member 302. The back member 302 has an opening 306 to align with the opening (120/220) and the input shaft receiver (110/210). The spacing between the extensions 304 again should be the same as the trailer jack 10. The bracket 300 and the extensions 304 in particular prevent the gearbox from rotating about the input shaft receiver 110/210 during use. As illustrated, the bracket 300 can be a separate item or it could be an integral portion of the back 106/206.

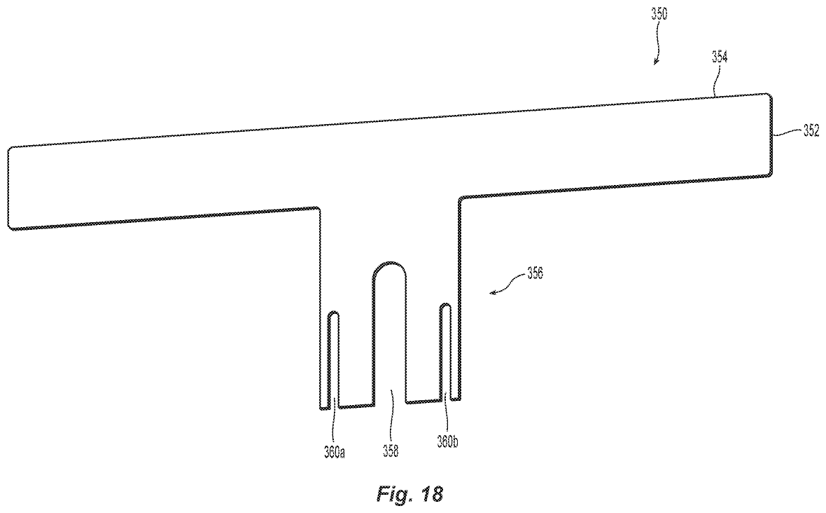

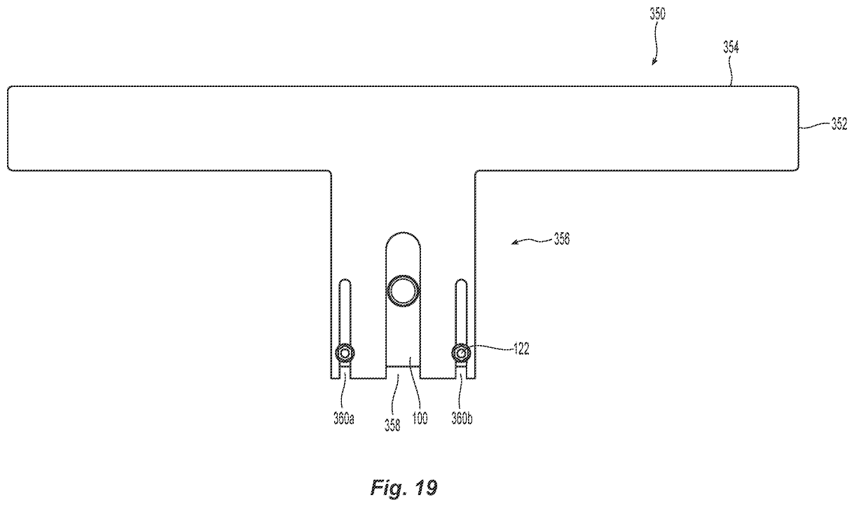

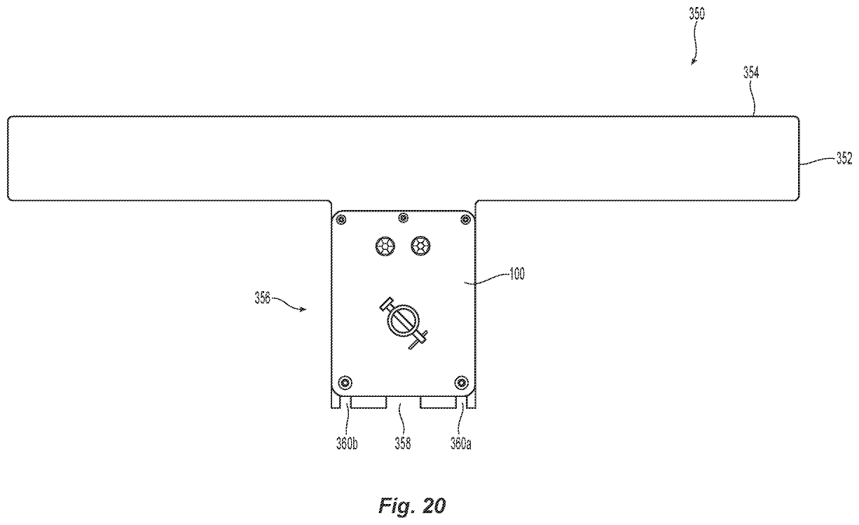

Another bracket 350 that can be used with the removable gearboxes (100/200) is illustrated in FIGS. 18-21. This bracket 350 was designed primarily to be used with the large semi-tractor trailers as the input shaft is in a different place than for the smaller trailers. The bracket 350 has an upper portion 352 and a top surface 354, in particular, that engages the trailer, and a lower portion 356 that slides down the back of the removable gearboxes (100/200). There are preferably three slots 358 and 360a/360b that cooperate with the screws and input shaft receiver. As illustrated in FIG. 19, the bracket 350 is attached to the removable gearbox 100. The screws 122 in the slots 360a/360b engage a portion of the bracket 350 and hold them still relative to one another. FIG. 20 shows the bracket 350 and the removable gearbox 100 from the front side.

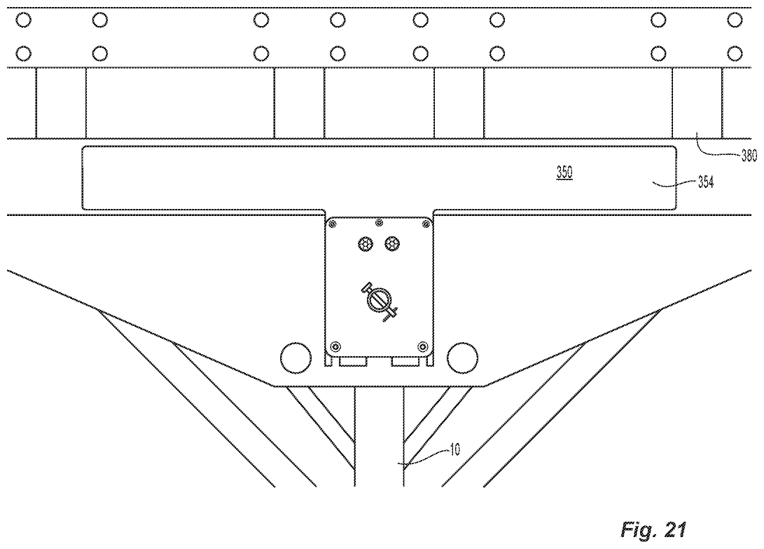

FIG. 21 shows the bracket 350 and the removable gearbox 100 attached to the input shaft of the trailer. The gearbox 100 is ready to be used with the trailer. If the removable gearbox 100 starts to rotate relative to the trailer, the top surface 354 engages the underside 380 of the trailer and prevents the removable gearbox 100 from rotating. The upper portion 352 may be either longer or shorter than illustrated. It is preferable that the upper portion 352 extend outward on both sides of the bracket 350 to prevent rotation of the removable gearbox 100 when it is either lowering or raising the trailer.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A removable gearbox to change a height of a trailer jack comprising:
a housing having a front and a back;
a plurality of gears disposed within the housing;
an input shaft receiver operatively connected to one of the plurality of gears, the input shaft receiver configured to receive at least a portion of an input shaft of the trailer jack therein and wherein the input shaft of the trailer is rotated to move a portion of the trailer jack up or down;
at least one gear shaft extending through the front of the housing, the at least one gear shaft attached to the another of the plurality of gears and the another of the plurality of gears is operatively connected to the one of the plurality of gears; and
two anti-rotation projections disposed on and extending away from the back of the housing to engage the trailer jack.

2. The removable gearbox according to claim 1, wherein the plurality of gears comprises a first gear, a second gear, a third gear, and a fourth gear and the one of the plurality of gears is the fourth gear and the another of the plurality of gears is the first gear.

3. The removable gearbox according to claim 1, wherein the input shaft of the trailer jack passes through at least one opening in the housing.

4. The removable gearbox according to claim 2, further comprising a second gear shaft extending through the front of the housing and being connected to the third gear, the third gear operatively connected to the fourth gear.

5. The removable gearbox according to claim 4, wherein the second gear and the third gear being connected to the second gear shaft.

6. The removable gearbox according to claim 2, wherein the second gear and the third gear are coaxial with each other.

7. The removable gearbox according to claim 2, wherein rotating the first gear shaft causes the first gear to rotate, which in turn causes the second gear and third gear to rotate, which in turn causes the fourth gear to rotate the input shaft of the trailer jack.

8. The removable gearbox according to claim 2, wherein rotating the second gear shaft causes the second gear and the third gear to rotate, which in turn causes the first gear and third gear to rotate, the second gear rotates the first gear and the third gear rotates the fourth gear causing the input shaft of the trailer jack to rotate.

9. The removable gearbox according to claim 1, wherein the input shaft receiver extends through the back of the housing.

10. The removable gearbox according to claim 1, wherein the first gear and the third gear have a first number of teeth, the second gear has a second number of teeth, and the fourth gear has a third number of teeth, where the third number of teeth is greater than the second number of teeth, and the second number of teeth is greater than the first number of teeth.

11. A removable gearbox to change a height of a trailer jack comprising:
a housing having a front and back;
a first gear, a second gear, a third gear and a fourth gear disposed within the housing;
an input shaft receiver operatively connected to the fourth gear, the input shaft receiver configured to receive at least a portion of an input shaft of the trailer jack therein;
a first gear shaft extending through the front of the housing, the first gear shaft is attached to the first gear and rotationally engages the second gear that is operatively connected to the input shaft receiver.

12. The removable gearbox according to claim 11, further comprising two projections extending away from a back portion of the housing to engage the trailer jack.

13. The removable gearbox according to claim 11, wherein the second and third gear are disposed on the same gear shaft, the third gear rotationally engaging the fourth gear thereby rotating the input shaft.

14. The removable gearbox according to claim 11, wherein the first gear shaft can operate in opposite directions.

15. The removable gearbox according to claim 11, further comprising a second gear shaft operationally coupled to the second and third gears.

16. The removable gearbox according to claim 11, wherein the back of the housing has two integrated projections to engage the trailer jack.

17. The removable gearbox according to claim 11, wherein rotating the first gear shaft causes the first gear to rotate, which in turn causes the second gear and third gear to rotate, which in turn causes the fourth gear to rotate the input shaft of the trailer jack.

18. The removable gearbox according to claim 11, wherein the first gear and the third gear have a first number of teeth, the second gear has a second number of teeth, and the fourth gear has a third number of teeth, where the third number of teeth is greater than the second number of teeth, and the second number of teeth is greater than the first number of teeth.
